(19) United States
(12) Patent Application Publication
(10) Pub. No.: US 2026/0049635 A1
(43) Pub. Date: Feb. 19, 2026

(54) SENSOR ROLLING BODY AND METHOD FOR PRODUCING A SENSOR ROLLING BODY

(71) Applicant: AKTIEBOLAGET SKF, GOTEBORG (SE)

(72) Inventors: Christoph BLEICHER, Steyr (AT); Stefan STROBL, Garsten (AT)

(21) Appl. No.: 19/297,292

(22) Filed: Aug. 12, 2025

(30) Foreign Application Priority Data
Aug. 19, 2024 (DE) 102024207843.3

(51) Int. Cl. F16C 19/52; B33Y 10/00; B33Y 80/00; F16C 33/34

(52) U.S. Cl. CPC F16C 19/52; B33Y 10/00; B33Y 80/00; F16C 33/34

(57) ABSTRACT

A sensor rolling body has a raceway layer and a sensor layer arranged radially on the inside of the raceway layer. At least one electronic device embedded in the sensor layer. The sensor layer and the at least one electronic device are each produced by an additive manufacturing process.

### CROSS-REFERENCE

This application claims priority to German patent application no. 102024207843.3 filed on Aug. 19, 2024, the contents of which are fully incorporated herein by reference.

### BACKGROUND OF THE INVENTION

The present invention relates to bearings, and more particularly to a sensor rolling body for a bearing and a method of producing such a sensor rolling body.

In the field of bearings, such as rolling bearings or plain bearings, it is necessary to monitor the condition of the bearings for reliable bearing operation and of the devices in which the bearings are installed. This can be achieved by the use of sensors that are installed in or on the bearing. However, there are a number of challenges to overcome with such sensors.

If active sensors are used, such sensors typically require cabling for operation, which is not easy to accomplish in rotating systems or applications with limited space, since the wires must be routed to the place of use (i.e., to the sensors). The use of wireless sensors in bearings and especially in rolling bodies is hampered, for example, by the shielding of metal-based materials typically used in the bearing industry. Such materials can prevent signals from being received or sent by the sensor, with the result that no usable data is obtained.

Sensor rolling bodies, in particular sensor rollers, that consist of a hollow roller and an inlet or insert are known. The insert includes measurement sensors and the associated electronics for transmitting the data. However, these sensor rollers are expensive to produce, since both the roller itself and the sensor insert must be manufactured separately and then assembled.

It is therefore an object of the present invention to provide a sensor rolling body that can be produced easily and cost-effectively.

### SUMMARY OF THE INVENTION

The object of the present invention is achieved by a sensor rolling body comprising a raceway layer and a sensor layer arranged radially on the inside of the raceway layer. At least one electronic device is embedded in the sensor layer and the sensor layer and the at least one electronic device are formed by an additive manufacturing method or process. The object is also achieved by a method of producing such a sensor rolling body.

As described above, the previously used sensor rolling bodies consist of a hollow roller and a separately produced sensor inlet which is inserted into the roller. The sensor inlet can be fitted with various sensors.

In order to simplify the production of the sensor rolling body in comparison with the previously known sensor rolling bodies, a sensor rolling body is proposed here, which has a raceway layer and a sensor layer that is arranged radially on the inside of the raceway layer, wherein at least one electronic device is embedded in the sensor layer, and wherein the sensor layer and the at least one electronic device are produced by means of an additive manufacturing method or process.

As used in the present disclosure, an “additive manufacturing” method or process can be understood as meaning various production methods, in which material is applied layer by layer in order to produce a three-dimensional workpiece, in this case the sensor layer with the at least one electronic device. Such additive manufacturing methods, which can generally also be referred to as 3D printing methods, include various production methods such as powder bed methods, free space methods (FDM, FFF), stereolithography, screen printing, laser sintering, binder jetting, extrusion (fused layer modelling), LDM (liquid deposition modelling), cold gas spraying, etc.

The sensor rolling body is therefore a multi-material rolling body or composite rolling body. The outer shell structure, which is in mechanical contact with the material of the bearing ring during operation, is designed as a raceway layer. The sensor layer with at least one embedded electronic device is arranged radially within this raceway layer. The sensor layer is produced together with the at least one electronic device in a single additive manufacturing method operation or process. In this way, this provides a cost-effective sensor rolling body that is simple to produce.

According to a further embodiment, the raceway layer may also be produced by means of an additive manufacturing method. Thus, it is possible to produce the entire sensor rolling body by means of an additive manufacturing method. This provides particularly advantageous production, since the sensor rolling body can be produced in any shape and size by means of an additive manufacturing method/process. In this way, the sensor rolling body can be flexibly adapted in terms of shape and/or size (e.g. diameter, inner bore or no inner bore, diameter of the inner bore, etc.) to different requirements.

According to a further embodiment, the stiffness of the sensor rolling body, or of its individual components such as the sensor layer, can be adjusted by the design of the individual layers and/or by the choice of the additive manufacturing method. This can be effected, for example, by means of grading in the porosity, the density or the structure and/or by providing hollow structures. This enables the elastic behavior of, for example, a rolling bearing steel or other materials to be modelled. For example, the elastic behavior of the raceway layer for rolling contact can be approximated to such materials, i.e. the surface pressure can be adjusted according to predefined design guidelines. This also allows the stiffness or the surface pressure distribution to be localized or adjusted overall.

According to a further embodiment, the thickness of the different layers can be varied as desired. This makes it possible to adapt the raceway layer and/or the sensor layer to different requirements. For example, the raceway layer may be thicker or thinner in order to withstand higher or lower loads. Similarly, the thickness of the sensor layer can be varied depending on the electronic device to be embedded. For example, the sensor layer can be designed to be sufficiently thick such that the electronic device is completely embedded. If the electronic device is not intended to be fully embedded, for example in order to allow contact with the electronic device, the sensor layer may be correspondingly thinner in order to partially release or expose the electronic device and not cover it. This can be useful, for example, for pH measurements, moisture content/water content, fluid temperature measurements, etc.

The additive manufacturing method can be carried out in the axial direction, wherein both the raceway layer and the sensor layer with the at least one electronic device can each be applied here layer by layer in the axial direction. Alternatively, the raceway layer can first be applied layer by layer in the axial direction and then the sensor layer, or vice versa. It is also possible for the layer to be applied layer by layer in the radial direction. The respective layer-by-layer application of the additive manufacturing method may depend in particular on the shape of the rolling body.

The printed layers can be bound together by diffusion processes during sintering. It must be ensured here that the difference in the thermal expansion of the two layers/layer systems does not lead to detachment. Furthermore, the different layers can be individually produced separately, as explained further below. The layers can then be joined, e.g. by adhesive bonding.

The sensor layer can serve as a substrate, i.e. as a carrier material, for the at least one electronic device (this can also be additively manufactured, either in-situ or separately introduced) and can have an electromagnetically permeable material. Since the sensor layer is electromagnetically permeable, electromagnetic waves from the at least one electronic device can be received and/or transmitted through the sensor layer. This enables sensor-based capture of parameters of a rolling bearing, in which the sensor rolling body can be installed.

According to a further embodiment, the electromagnetically permeable material comprises polymer, ceramic, and/or metal. In addition, low-density material combinations, such as foams, can be used, for example. Other examples include aluminum nitride ceramic (AlN), aluminum oxide ceramic (Al2O3) or LTCC ceramic. Aluminum nitride ceramic, for example, has the advantage that AlN has good thermal conductivity and temperature management. Furthermore, AlN can be easily combined with silicon nitride, a material from which the raceway layer can be produced, for example. This means that the sensor layer can be safely and reliably connected to the raceway layer when using AlN.

LTCC ceramic, so-called low temperature cofired ceramic, can be used, for example, to produce multi-layer circuits based on sintered ceramic carriers. If this material is used for the sensor layer, the at least one electronic device, for example conductor tracks, capacitors, resistors and coils, can be introduced into the ceramic material of the sensor layer. For this purpose, the at least one device can be applied to the ceramic material, for example by means of screen printing or photochemical processes.

According to a further embodiment, the sensor rolling body has a covering layer which is arranged radially on the inside over the at least one electronic device. In particular, the covering layer can be applied as protection for the sensor layer. This is especially possible if the sensor layer or the electronic device embedded therein does not have to be connected to the environment.

If the covering layer is only used to cover the sensor layer, e.g. in order to prevent the sensor layer from coming into contact with the outside environment, the covering layer may consist of the same material as the sensor layer. In this way, the covering layer can be easily applied or printed in the same operation of the additive manufacturing method as the sensor layer.

According to a further embodiment, the covering layer and the sensor layer comprise different materials, i.e., are formed of different materials. The covering layer may include, for example, polymers, resins and/or composites. The covering layer can also perform a mechanical function in addition to or as an alternative to a protective function as described above. Such a mechanical function may generally be, for example, a supporting effect, an increase in the overall component size, the transfer of loads or the effect as a reinforcing layer in the sense of crack deflection, crack branching or general crack bridge behavior, etc. Strain compensation is also possible, in a similar way to laminate layers, e.g. by means of layers prestressed with internal stresses.

According to a further embodiment, the sensor rolling body has at least one connecting element which is arranged in contact with the covering layer and the at least one electronic device. Such a connecting element can be used, for example, to connect the sensor layer or the at least one electronic device to further sensors outside the sensor layer. Such sensors may be, for example, heat-sensitive sensors that would not survive unscathed during a sintering step, as is carried out in a ceramic sensor layer. In order to be able to integrate such sensors, for example plug-and-play sensors, connection holes and/or slots can be provided in the sensor layer and/or the covering layer.

According to a further embodiment, the electronic device comprises an antenna (e.g. RFID antenna for wireless connections), a sensor and/or an electrical line. Furthermore, the electronic device may include capacitors, inductors, resistors, transformers, and/or hybrid circuits.

Conductive, resistive, piezoelectric and dielectric materials can thus be embedded in the sensor layer and form the at least one electronic device. For example, materials from the class of piezoelectrics, NTC, PTC can be used to produce a thermosensitive element or switch-off element. A mixture of Si3N4 and MoSi2, which in the sintered state result in an electrically conductive-insulating combination, is also possible.

Sensors in the sensor layer can comprise sensors for monitoring temperature, humidity, strain/stress, vibration, acceleration, rotational speed, electrical and magnetic fields (e.g., Hall effect sensors, etc.), gas and other concentration measurements (e.g. pH, H₂, ammonia, etc.). Sensors can also detect misalignments within the bearing. A two-sensor system, for example, can be used for this purpose, wherein in the sensor rolling body, either two sensors may be implemented at two opposite ends of the sensor rolling body or two sensor rolling bodies each with a sensor can be implemented. In addition, condition monitoring for lubrication systems can also be achieved, e.g. via pH monitoring. In summary, any kind of sensor technology that is desired for using the sensor rolling body in a rolling bearing can be implemented by the sensor layer.

According to a further embodiment, the raceway layer has metal, in particular steel (e.g. bearing steel), and/or ceramic, in particular silicon nitride. Using such materials for the raceway layer makes it possible to ensure that the raceway layer, and thus the sensor rolling body, withstands the standard operating conditions in a bearing. With such a material selection, no specific load and speed limits therefore need to be adhered to.

According to a further aspect, a method for producing a sensor rolling body as described above is proposed. The method comprises the following steps of:
providing a raceway layer;
applying a sensor layer, layer by layer, together with at least one electronic device by means of an additive manufacturing method; and
arranging the sensor layer radially on the inside of the raceway layer.

An existing outer shell of a hollow roller (in the case of a sensor roller) or another hollow body that represents the raceway layer can be used, for example, to produce the sensor rolling body. The sensor layer can then be applied in this hollow body. Alternatively, the sensor layer can be applied around the existing outer shell and the raceway layer will in turn be applied around the sensor layer. In this case, for example, the outer shell can be coated with a material suitable for the sensor layer. Shrinkage-free materials are also possible here (e.g. shrinkage-free LTCC; shrinkage here is limited only to the /direction/ or the radial component). The outer shell with the shrinkage-free material can then be fired under suitable conditions.

Alternatively, the provision of the raceway layer may also comprise applying the raceway layer, layer by layer, by means of the additive manufacturing method. In this case, the sensor rolling body consisting of at least the sensor layer produced by means of additive manufacturing and the raceway layer produced by means of additive manufacturing can be fired simultaneously. The layer-by-layer application can be carried out, for example, as multi-material 3D printing, in order to be able to produce the sensor layer and the raceway layer from different materials.

According to a further embodiment, the method further comprises applying a covering layer, layer by layer, radially on the inside of the sensor layer over the at least one electronic device. As already explained above, a covering layer may be provided in order to protect the sensor layer and in particular the electronic device. The covering layer can consist of the same material as the sensor layer. Alternatively, the covering layer can consist of a material different than a material of the sensor layer. In the latter case, the covering layer can perform its own functions which go beyond the pure coverage and the protection of the electronic device from contact. Such functions may be, for example, protection from mechanical influences, wherein the covering layer in this case can consist of materials that can withstand such mechanical influences.

The sensor rolling body proposed here is compatible with any type of standard rolling bodies and standard rolling bearings. Therefore, any rolling bearing can be enhanced by replacing a standard steel or ceramic rolling body with a measurement and monitoring system. This makes it possible to easily observe and monitor the condition of the bearing in situ.

If a ceramic raceway layer is chosen for the sensor rolling body, the advantages of using a single ceramic rolling body in a bearing otherwise consisting entirely of steel (in which the remaining rolling bodies may also consist of steel) can be combined. The single ceramic rolling body keeps the steel raceway free of foreign objects in dusty and dirty environments. It smooths the raceways, which increases the service life under dirty conditions while simultaneously reducing wear. One or more sensor rolling bodies can also be used in a bearing.

Further advantages and advantageous embodiments are specified in the description, the drawings and the claims. In particular the combinations of the features specified in the description and in the drawings are purely illustrative here, and therefore the features can also be present individually or in other combinations.

### BRIEF DESCRIPTION OF THE SEVERAL VIEWS OF THE DRAWINGS

The invention shall be described in more detail below with reference to exemplary embodiments shown in the drawings. The exemplary embodiments and the combinations shown in the exemplary embodiments are purely illustrative and are not intended to define the scope of protection of the invention. The latter is defined solely by the appended claims. In the drawings:

FIG. 1 is a schematic view of a sensor rolling body in an axial cross section; and

FIG. 2 is a schematic view of the sensor rolling body from FIG. 1 in a radial cross section.

### DETAILED DESCRIPTION OF THE INVENTION

Identical or functionally identical elements are identified by the same reference signs below.

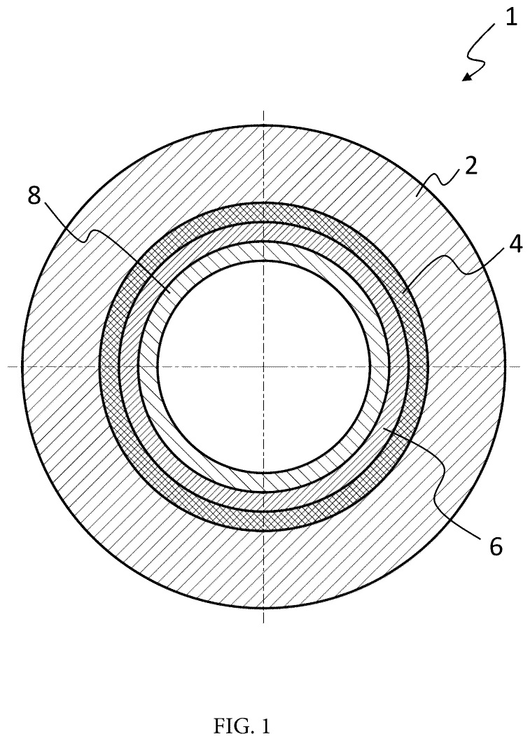

FIG. 1 shows a sensor rolling body 1. As shown in the figures, this sensor rolling body 1 can be a sensor roller, but can also be any other type of sensor rolling body, such as a ball, a pendulum roller, etc. The sensor rolling body 1 can be used in any rolling bearing and can, for example, replace one of the already existing rolling bodies in order to make it possible to monitor the rolling bearing.

The sensor rolling body 1 has a raceway layer 2 and a sensor layer 4. One or more electronic devices 6 may be embedded in the sensor layer 4, which is arranged radially on the inside of the raceway layer 2. For the sake of simplicity, the one or more electronic devices 6 are shown as a single continuous layer. However, it should be understood that the electronic devices 6 may also be implemented by one or more individual elements which may be embedded as separate elements in the sensor layer 4.

The one or more electronic devices 6 may be, for example, sensors, antennas, electrical lines, chips, or any other electronic devices. The one or more devices 6 can be used to monitor the sensor rolling body 1 or the bearing in which the sensor rolling body 1 is installed, for example by capturing parameters of the sensor rolling body 1 or the bearing, such as vibration, temperature, load, etc. Furthermore, the one or more electronic devices 6 can be used to transmit such captured parameters to external devices, e.g. control units, monitoring devices, etc. For this purpose, the electronic device 6 may be designed, for example, as an antenna or may include an antenna.

In order to now make it possible to easily produce the sensor rolling body 1, the sensor layer 4 and the at least one electronic device 6 are produced by means of an additive manufacturing method. In this way, the sensor layer 4 and the electronic device(s) 6 can be produced in a single step.

Optionally, the raceway layer 2 can also be produced by means of an additive manufacturing method. This has the advantage that the sensor rolling body 1 can be produced in a simple and cost-effective way by means of a single method.

If the electronic device 6 is intended to be protected, a covering layer 8 can be applied to the sensor layer 4 in such a way that at least the electronic device 6 is partially or entirely covered. Optionally, the complete sensor layer 4 can also be covered by the covering layer 8. The covering layer 8 can consist of the same material as the sensor layer 4, which facilitates production. Alternatively, the covering layer 8 may consist of another material and can, for example, provide its own properties. Such properties can be, for example, insulating properties. The covering layer 8 can also be produced by way of an additive manufacturing method.

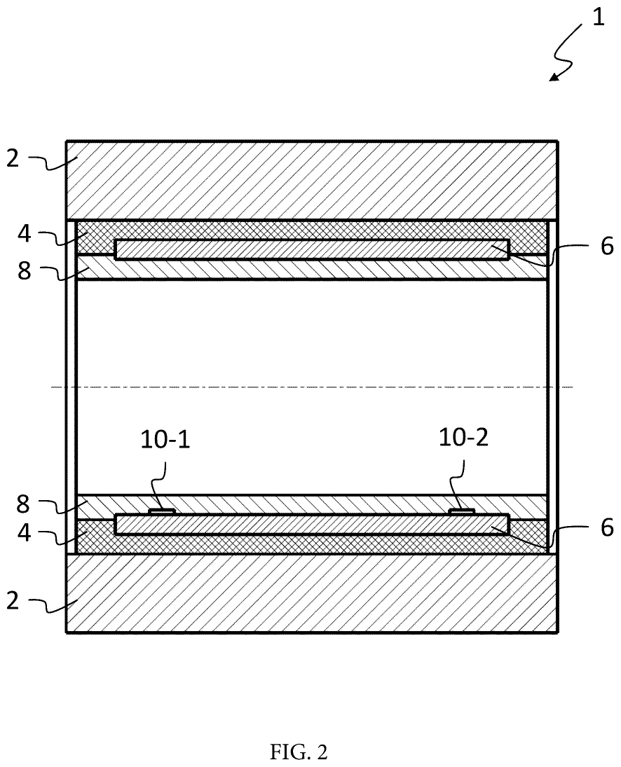

As can be seen in FIG. 2, the electronic device 6 can be completely surrounded by the sensor layer 4 and the covering layer 8. It is also possible to provide openings (not shown) in the sensor layer 4 and/or the covering layer 8, such openings enabling, for example, to guide cables from the electronic device 6 to the outside or to make contact with the electronic device 6 in another way.

As can be seen in FIG. 2 in the lower area of the sectional drawing, optional connecting elements 10-1, 10-2 may be provided. The connecting elements 10-1, 10-2 can also be used to make contact with the electronic device 6. The connecting elements 10-1, 10-2 can further establish a connection between the electronic device 6 and the covering layer 8, in order to be able to capture, for example, a pressure or other property on or of the covering layer 8.

In summary, a sensor rolling body 1 which can be produced in a simple and cost-effective way is provided by the present invention.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### LIST OF REFERENCE SIGNS

1 Sensor rolling body
2 Raceway layer
4 Sensor layer
6 Electronic device
8 Covering layer
10-1, 10-2 Connecting element

We claim:

1. A sensor rolling body comprising:
a raceway layer;
a sensor layer arranged radially on the inside of the raceway layer; and
at least one electronic device embedded in the sensor layer;
wherein the sensor layer and the at least one electronic device are formed by an additive manufacturing process.

2. The sensor rolling body according to claim 1, wherein the raceway layer is produced by an additive manufacturing process.

3. The sensor rolling body according to claim 1, wherein the sensor layer provides a substrate for the at least one electronic device and includes an electromagnetically permeable material.

4. The sensor rolling body according to claim 3, wherein the electromagnetically permeable material includes a polymer, a ceramic, and/or a metal.

5. The sensor rolling body according to claim 1, wherein a covering layer is arranged radially on the inside over the at least one electronic device.

6. The sensor rolling body according to claim 5, wherein the covering layer and the sensor layer are formed of different materials.

7. The sensor rolling body according to claim 5, wherein at least one connecting element is arranged in contact with the covering layer and the at least one electronic device.

8. The sensor rolling body according to claim 1, wherein the electronic device includes an antenna, a sensor and/or an electrical line.

9. The sensor rolling body according to claim 1, wherein the raceway layer includes a metal and/or a ceramic.

10. The sensor rolling body according to claim 9, wherein the metal is steel and the ceramic is silicon nitride.

11. A method for producing a sensor rolling body, the method comprising the steps of:
providing a raceway layer; and
applying a sensor layer and at least one electronic device radially inside the raceway layer, the sensor layer being applied layer by layer in an additive manufacturing process.

12. The method according to claim 11, wherein step of providing the raceway layer includes forming the raceway layer, layer by layer, by an additive manufacturing process.

13. The method according to claim 11, further comprising a step of applying a covering layer radially on the inside of the sensor layer over the at least one electronic device layer by layer by an additive manufacturing process.
